(19) United States
(12) Patent Application Publication
(10) Pub. No.: US 2025/0384794 A1
(43) Pub. Date: Dec. 18, 2025

(54) MULTI-LAYERED TAG AND METHOD OF MANUFACTURING THEREOF

(71) Applicant: Multi Packaging Solutions, Inc., Atlanta, GA (US)

(72) Inventors: Michelle DIXON, Lansing, MI (US); Bernard A. KRAUS, Mechanicsville, VA (US); Chitai C. YANG, Glen Allen, VA (US)

(21) Appl. No.: 18/876,102

(22) PCT Filed: Jun. 16, 2023
(86) PCT No.: PCT/US2023/025564

§ 371 Date: Dec. 17, 2024

Related U.S. Application Data
(60) Provisional application No. 63/353,266, filed on Jun. 17, 2022.
(60) Provisional application No. 63/353,268, filed on Jun. 17, 2022.

(51) Int. Cl. G09F 3/02; A01G 9/00

(52) U.S. Cl. CPC G09F 3/02; A01G 9/00; G09F 2003/026; G09F 2003/0261; G09F 2003/0266; G09F 2003/0272

(57) ABSTRACT

A horticultural tag comprising: (a) a first outer layer made from a polymer; (b) a second outer layer made from a polymer; and (c) an intermediate layer made from a paperboard, wherein the paperboard is infused with wax prior to joining the first outer layer, the second outer layer, or both to the intermediate layer. The horticultural tag may be adapted for hanging or attachment to a plant. The horticultural tag may also be adapted for at least partial insertion in soil surrounding a potted or planted plant.

### CROSS-REFERENCE TO RELATED APPLICATIONS

This application claims priority to and the benefit of U.S. Provisional Application No. 63/353,266, filed Jun. 17, 2022, and U.S. Provisional Application No. 63/353,268, filed Jun. 17, 2022, the entire disclosures of which are incorporated by reference herein.

### FIELD

The present teachings generally relate to a horticultural tag, and more particularly, to a multi-layered, environmentally friendly horticultural tag.

### BACKGROUND

The horticultural industry often utilizes a variety of tags to help organize various plants, convey information to a consumer or retail establishment, or both. The tags may often provide information regarding a specific type of plant, care instructions for the identified plant, price information (if in a retail establishment), a barcode for scanning a retail establishment point-of-sale (POS), or a combination thereof. Similarly, if not within a retail establishment, the tags may help serialize plants during growth at an agricultural site. Often times, the tags are hung or otherwise secured to the plants directly. Similarly, the tags may also not be in direct contact with the plant, but rather inserted directly into the soil surrounding the plant.

Due to the tags often being located on or near plants outside, the tags are often required to be durable enough to withstand the elements, such as moisture, ultraviolet (UV) exposure (e.g., sun exposure), wind, or a combination thereof. As a result, the tags may be required to be manufactured using materials that are able to withstand the aforementioned elements without fracturing, breaking, or deteriorating for a desired amount of time. Similarly, the tags may be required to exhibit certain material characteristics, such as a desired stiffness (i.e., rigidity), durability at heightened or significantly lowered temperatures, moisture-resistance, UV-resistance, or a combination thereof. Even further, the tags may be required to have certain shapes to accommodate insertion into the ground, hanging, or both.

Due to these requirements, tags are often constrained to specific materials. For example, conventional horticultural tags may often utilize plastics, metals, or a combination thereof to ensure proper manufacturing of a desired shape while still being able to prevent material degradation. However, these conventional tags may frequently not be environmentally friendly and may often require conventional disposal as waste without the ability of recycling. Additionally, many of the conventional materials used for horticultural tags may often have difficulties withstanding extreme temperatures (e.g., freezing temperatures), moisture, or both. In these instances among others, the conventional tags may be brittle and shatter, may absorb moisture and deteriorate or otherwise lose structural integrity, or both.

Based on the above, there remains a need for a horticultural tag that provides an environmentally friendly alternative to conventional tags. What is needed is a horticultural tag that is made from a sustainable material. Additionally, there remains a need for a horticultural tag that exhibits and maintains desired material properties when exposed to extreme environmental conditions. What is needed is a horticultural tag that maintains structural integrity at fluctuating temperatures. Moreover, there remains a need for a horticultural tag that utilizes renewable materials yet still provides proper moisture resistance. What is needed is a horticultural tag that is environmentally friendly yet still ensures material integrity upon exposure to moisture.

### SUMMARY

The present teachings meet one or more of the present needs by providing a horticultural tag comprising: (a) a first outer layer made from a polymer; (b) a second outer layer made from a polymer; and (c) an intermediate layer made from a paperboard, wherein the paperboard is infused with wax prior to joining the first outer layer, the second outer layer, or both to the intermediate layer.

The first outer layer, the second outer layer, or both may be made from a thermoplastic material. The first outer layer, the second outer layer, or both may be made from polyethylene. The first outer layer, the second outer layer, or both may be made from low density polyethylene (LDPE).

The first outer layer and the second outer layer may be made from the same material. The first outer and the second outer layer made be made from different materials.

The first outer layer, the second outer layer, or both may include a surface finish. The first outer layer may include a matte surface finish. The second outer layer may include a gloss surface finish. The first outer layer, the second outer layer, or both may include printing. The horticultural tag may be corona treated to ensure adhesion during printing on the first outer layer, the second outer layer, or both. Additionally, printing may be completed with ultraviolet (UV) ink, aqueous ink, or both.

The first outer layer, the second outer layer, or both may be made from a bio-based plastic such that the horticultural tag is compostable. The horticultural tag may be moisture wicking, moisture resistant, or both. The intermediate layer may be moisture wicking, moisture resistant, or both.

The horticultural tag may be adapted for hanging or attachment to a plant. The horticultural tag may be adapted for at least partial insertion into soil surrounding a potted or planted plant.

Additionally, the intermediate layer may be uncoated. The first outer layer, the second outer layer, or both may be extruded over the intermediate layer, and the resultant multi-layer material may be die cut to form the horticultural tag.

The present teachings meet one or more of the present needs by providing a horticultural tag comprising: (a) first outer layer made from a thermoplastic; (b) a second outer layer made from a thermoplastic; and (c) an intermediate layer made from a paperboard, wherein the first outer layer, the second outer layer, or both are heat sealed to the intermediate layer to seal the intermediate layer therein.

The first outer layer, the second outer layer, or both may be made from a plant-based plastic or bioplastic. The first outer layer may be made from polybutylene succinate (PBS). The second outer layer may be made from polybutylene succinate (PBS). The first outer layer, the second outer layer, or both may be biodegradable. The first outer layer and the second outer layer may be made from the same material. The first outer layer and the second outer layer may be made from different materials. The first outer layer and the second outer layer may include a surface finish.

The first outer layer, the second outer layer, or both may be heat sealed around peripheral edges of the intermediate layer such that the intermediate layer is fully covered by the first outer layer, the second outer layer, or both.

The first outer layer, the second outer layer, or both may include printing. Printing may be completed with ultraviolet (UV) ink, aqueous ink, or both. The horticultural tag may be moisture wicking, moisture resistant, or both. The horticultural tag may be adapted for hanging or attachment to a plant. The horticultural tag may be adapted for at least partial insertion into soil surrounding a potted or planted plant. The intermediate layer may be uncoated.

The first outer layer, the second outer layer, or both may be extruded over the intermediate layer, and the resultant multi-layer material may be die cut to form the horticultural tag. The horticultural tag may be corona treated to ensure adhesion during printing on the first outer layer, the second outer layer, or both. The horticultural tag may be heat-sealed after die cutting. Additionally, the horticultural tag may maintain structural integrity at a temperature of about −30° or more.

The present teachings may also meet one or more of the present needs by providing: a horticultural tag that provides an environmentally friendly alternative to conventional tags; a horticultural tag that is made from a sustainable material; a horticultural tag that exhibits and maintains desired material properties when exposed to extreme environmental conditions; a horticultural tag that maintains structural integrity at fluctuating temperatures; a horticultural tag that utilizes renewable materials yet still provides proper moisture resistance; a horticultural tag that is environmentally friendly yet still ensures material integrity upon exposure to moisture; or a combination thereof.

Furthermore, the present teachings may also meet one or more of the present needs by providing: a horticultural tag that provides an environmentally friendly alternative to conventional tags; a horticultural tag that is made from a sustainable material; a horticultural tag that exhibits and maintains desired material properties when exposed to extreme environmental conditions; a horticultural tag that maintains structural integrity at fluctuating temperatures; a horticultural tag that utilizes renewable materials not conventionally used yet still provides desired material characteristics; a horticultural tag that is environmentally friendly yet still ensures material integrity upon exposure to moisture; or a combination thereof.

### BRIEF DESCRIPTION OF THE DRAWINGS

FIG. 1A is a front view of a horticultural tag in accordance with the present teachings.

FIG. 1B is a front view of a horticultural tag in accordance with the present teachings.

FIG. 1C is a front view of a horticultural tag in accordance with the present teachings.

FIG. 2A is a front view of a horticultural tag in accordance with the present teachings.

FIG. 2B is a front view of a horticultural tag in accordance with the present teachings.

FIG. 2C is a front view of a horticultural tag in accordance with the present teachings.

FIG. 2D is a front view of a horticultural tag in accordance with the present teachings.

FIG. 3 is a cross-sectional view of a horticultural tag in accordance with the present teachings.

FIG. 4 is a cross-sectional view of a horticultural tag in accordance with the present teachings.

### DETAILED DESCRIPTION

The present teachings generally relate to a tag, and more specifically, a horticultural tag. However, it is envisioned that the tag as described herein may be implemented in various other industries other than horticulture, such as the food and beverage industry, construction industry, various consumer product industries, or a combination thereof. For example, while discussions herein may pertain to a tag related to a plant, the tag could also identify a location within a construction site, a food or beverage product, outdoor consumer products, or a combination thereof.

The tag may function to identify a plant. The tag may function to convey information about a particular plant. The tag may identify and/or convey information regarding a particular plant by securing the tag directly to the plant. For example, the tag may include a hanging feature or hanging mechanism that connects the tag to a stem of the plant, a leaf of the plant, or both. The hanging feature or hanging mechanism may include, but is not limited to, hooks, holes, projections, slits, perforations, score lines, cutouts, or a combination thereof. For example, the tag may include an integrally (i.e., monolithically) formed hole or hook that connects to the plant directly. Additionally, the tag may be secured to the plant using an additional connection means. The additional connection means may be string, twine, a secondary hook, adhesive (e.g., tape), or a combination thereof that connect the tag to the plant.

In addition to securing the tag directly to the plant, it is also envisioned that the tag may be secured adjacent to the plant without direct contact to the plant. For example, the tag may be at least partially inserted into soil surrounding the plant. As a result, the tag may advantageously avoid any potential harm to the plant during attachment, yet still convey the desired information pertaining to the plant.

Due to utilization in the horticulture industry, the tag may be required to exhibit certain material properties. These material properties may correlate to environmental exposure to the tag when attached or indirectly connected to a plant (e.g., inserted into the ground). For example, the plants may frequently be stored or planted outside. As a result, an associated tag may also be exposed to the outdoors. Thus, the tag may be exposed to moisture and/or debris that could cause degradation to the tag. For example, snow, rain, watering of the plants, or a combination thereof may contact the tag and cause the tag to deteriorate.

Similarly, the tags may frequently be exposed to significant temperature fluctuations either outdoors or in interior growing environments. That is, the tag may be exposed to temperatures in the range of about −30°° C. to about 60° C., about −15° C. to about 45° C., about 0° C. to about 30° C., or about 10° C. to about 25° C. Thus, it may be gleaned from the present teachings that the tag could be exposed to significantly colder or hotter temperatures when compared to an ambient temperature. As a result, the tag may be required to maintain structural integrity during such temperature fluctuations to avoid melting, brittleness, cracking, other deformation, or a combination thereof. For example, conventional horticultural tags may frequently be unable to withstand colder temperatures (e.g., below about 0° C.) due to brittleness which may cause the conventional plastic material of the tags to crack when being secured to a plant. Here, the present teachings contemplate a solution to alleviate these issues by utilizing a more unique material structure for the horticultural tags.

Even further, it is envisioned that the tag may beneficially provide additional material integrity. The tag may be corrosion resistant, anti-fungal, anti-bacterial, moisture wicking, ultraviolet (UV) resistant, chemical resistant, or a combination thereof. Therefore, based on the above, the tag as taught herein may prevent unwanted degradation when the tag is located outdoors, within soil, or both.

Advantageously, the tag as taught herein may not only exhibit the above characteristics but also provide an environmentally friendly alternative to conventional horticultural tags. That is, the tag may be fully recyclable or compostable after use to decrease its carbon footprint and impact on the environment. Similarly, the tag may be biodegradable, compostable, or both after a desired duration of time as required by the horticulture industry.

To provide a fully compostable tag, it is envisioned that the tag entirely or at least partially made from fully plant-based materials or other biological materials. The tag may about 50% plant-based or more, about 60% plant-based or more, or even 70% plant-based or more. The tag may be about 100% plant-based or less, about 90% plant-based or less, or about 80% plant-based or less. The composition of the material of the tags may be certified compostable per ASTM D6400 and/or ASTM D6868, all of which is incorporated herein in its entirety for all purposes.

The tag may include one or more layers. The tag may include one or more layers, two or more layers, three or more layers, four or more layers, five or more layers, or even six or more layers. One particular configuration may include a plurality of outer layers sandwiching one or more intermediate layers. For example, the tag may include opposing outer layers that are positioned on opposing sides of an intermediate layer. Due to such a composite configuration, the tag may advantageously combine like material layers or dissimilar material layers to tune material properties of the tag.

An intermediate layer may function as a base layer for the tag. The intermediate layer may differ from additional layers (e.g., outer layers) or may be the same as some or all of the additional layers. Similarly, the intermediate layer may comprise a plurality of intermediate layers that are positioned adjacent to or between one or more outer layers.

The intermediate layer may vary in materials. However, it is envisioned that the intermediate layer may be a paperboard material. The paperboard material may be boxboard such as folding boxboard (FBB), chipboard, Kraft board, laminated board, solid bleached board (SBB), solid unbleached board (SUB), containerboard, cupstock, or a combination thereof. The paperboard may be corrugated or may be substantially smooth. The paperboard may be bleached or unbleached. The paperboard may be coated or uncoated. It should be noted that the paperboard selected for the intermediate layer may be substantially or completely compostable using environmentally friendly (e.g., renewable) materials.

The intermediate layer may vary in thickness. The intermediate layer may have a consistent or uniform thickness. The thickness of the intermediate layer may about 0.25 millimeters (mm) or more, about 0.5 mm or more, or about 1 mm or more. The thickness of the intermediate layer may be about 3 mm or less, about 2 mm or less, or about 1 mm or less. However, the thickness of the intermediate layer or the plurality of intermediate layers may be configured based on a given application.

Conventional horticultural tags may have been unable or dissuaded to utilize a paperboard material as a base material. Conventional paperboard materials may frequently absorb water or otherwise be unable to withstand moisture, thereby rendering the paperboard a fragile material for horticultural applications. For example, due to plants frequently being outside and subject to environmental elements (e.g., rain, storms, hail, snow, etc.) or simply from being watered during growing stages, a conventional paperboard material may break down and be unable to withstand such exposure.

Beneficially, the present teachings provide a solution to such an issue. Specifically, the paperboard material utilized for the intermediate layer or any additional layers may initially be infused by a wax prior to forming the horticultural tag. To do so, the paperboard material may be soaked in a desired volume of heated wax (e.g., liquid form) for a duration of time to allow the wax to penetrate into the paperboard material. Once sufficiently soaked with wax, the paperboard material (e.g., the intermediate layer) may be assembled with the additional layers to form the tag. Advantageously, such an infusion or soaking may aid with moisture resistance of the paperboard, thereby significantly improving its material integrity for horticultural applications that may be frequently exposed to rain and other elements.

The paperboard material may be infused and/or soaked in a variety of waxes. The wax may be a beeswax, a paraffin wax, a soy wax, a carnauba wax, a mineral wax, a stearate wax, or a combination thereof. The wax utilized may vary in melting points, operating temperature, cold flow characteristics, or a combination thereof. The wax may also be applied as a wet wax treatment or a dry wax treatment. As a result, the waxes may be adapted for a variety of manufacturing processes based upon the desired final characteristics of the tag.

The intermediate layer (e.g., the paperboard material) may be soaked in a heated wax for a period of about 1 hours or more, about 2 hours or more, or about 5 hours or more. The intermediate layer (e.g., the paperboard material) may be soaked in a heated wax for a period of about 10 hours or less, about 7 hours or less, or about 5 hours or less. As such, depending on the selected wax or combination of waxes used, the infusion time may be adjusted to ensure that the intermediate layer is acceptably penetrated by the wax.

Additionally, once infusion and/or soaking has been completed, the intermediate layer may cure or rest for a set amount of time to ensure proper penetration. The intermediate layer (e.g., the paperboard material) may rest for a period of about 1 hours or more, about 24 hours or more, or about 48 hours or more. The intermediate layer (e.g., the paperboard material) may rest for a period of about 45 days or less, about 30 days or less, or about 3 days or less.

Similarly, it may be gleaned in the present teachings that the temperature for heating the wax, volume of wax used for infusion/soaking, viscosity of the wax used for infusion/soaking, other material properties of the wax, of a combination thereof may also be adjusted to properly infuse the intermediate layer. Additionally, depending on the type of paperboard used for the intermediate layer, the aforementioned characteristics may need to be adjusted. Moreover, manufacturing processes may also be adjusted to ensure proper wax infusion. Manufacturing adjustments such as wax application speed, wax application pressure, wax application rate, or a combination thereof may be made based on a given application.

As discussed above, the intermediate layer or intermediate layers may be adjoined to one or more additional layers. For example, the intermediate layer may be joined to one or more outer layers that are disposed along a surface of the intermediate layer to form the horticultural tag. The outer layers may be disposed along a single surface of the intermediate layer or may be disposed on opposing surfaces of the intermediate layer to sandwich the intermediate layer. The outer layers may be the same material as the intermediate layer. However, it is envisioned that the outer layers may be a different material than the intermediate layer.

To facilitate the use of a paperboard material as the intermediate layer, the tag as described herein may also include one or more heat sealable outer layers. As such, the outer layers may advantageously seal along one or more surfaces of the intermediate layer to protect the intermediate layer from degradation caused by moisture and/or debris. Similarly, the outer layers may also heat seal along a periphery (e.g., a peripheral edge) of the intermediate layer to substantially or fully encapsulate the intermediate layer within the outer layers. As a result, substantially all or all exposed surfaces of the intermediate layer may be covered by the outer layers. It should be noted that heal sealing as described above may be used in lieu or, or in conjunction with, the infusion and/or soaking implementations described above.

Additionally, while heat sealing has been discussed above with respect to the outer layers joining to the intermediate layer, alternative options may be possible. For example, the outer layers may be skived and/or hemmed where applicable to protect the intermediate layer and provide a horticultural tag as described herein. As such, it is envisioned that the outer layers may be extruded or otherwise disposed along the intermediate layer, whereby then the outer layers may be heat sealed, skived, hemmed, or a combination thereof to create the resultant horticultural tag.

The outer layers may be disposed along a single surface of the intermediate layer or may be disposed on opposing surfaces of the intermediate layer to sandwich the intermediate layer. The outer layers may be the same material as the intermediate layer. However, it is envisioned that the outer layers may be a different material than the intermediate layer.

The outer layers may be a polymer material. The outer layers may be a thermoplastic material. The outer layers may be a polyethylene-based material, such as low density polyethylene (LDPE), high density polyethylene (HDPE), or a combination thereof. Alternatively, or additionally, the outer layers may be an aliphatic polyester. The outer layers may be biodegradable aliphatic polyester. For example, the outer layers may be polybutylene succinate (PBS), thereby providing an environmentally friendly, biodegradable material to at least partially encapsulate the intermediate layer in certain configurations. As such, it is envisioned that the outer layers may be moisture resistant, ultraviolet (UV) resistant, impact resistant, or a combination thereof.

The outer layers may include a surface treatment. For example, the outer layers may include an ozone treatment or other types of treatment to modify surface energy of the outer layers and help ensure adhesion of the outer layers to the intermediate layer, one another, printing ink (e.g., UV ink, aqueous ink, or both), or a combination thereof.

The outer layers may vary in thickness from each other, the intermediate layer, or both. The outer layers may have a uniform thickness. The outer layers may have a thickness of about 0.1 millimeters (mm) or more, about 0.5 mm or more, or about 1 mm or more. The outer layers may have a thickness of about 2 mm or less, about 1.5 mm or less, or about 1 mm or less.

In some desired applications, the outer layers may be made from a plant-based plastic or bioplastic. The plant-based plastic or bioplastic may be or may include starch-based, cellulose-based, protein-based, or a combination thereof. The plant-based plastic or bioplastic may be biologically derived polyethylene, such as those produced from the fermentation of raw agricultural materials like sugarcane and/or corn. The plant-based plastic or bioplastic may be an aliphatic polyester.

The plant-based plastic or bioplastic material may be polylactic acid (PLA). The plant-based plastic or bioplastic may be poly (butylene adipate-co-terephthalate) (PBAT). The plant-based plastic or bioplastic may polyglycolic acid (PGA). The plant-based plastic or bioplastic may be poly-ε-caprolactone (PCL). The plant-based plastic or bioplastic may be polyhydroxybutyrate (PHB). The plant-based plastic or bioplastic may be poly(3-hydroxy valerate). The plant-based plastic or bioplastic may be polybutylene succinate (PBS), poly(butylene succinate-co-butylene adipate) (BPSA), or both.

The plant-based plastic or bioplastic material may also be a combination of one or more plant-based plastics or bioplastics. That is, the outer layers may be made from a plurality of plant-based plastics or bioplastics such that the material may beneficially be tuned to meet one or more desired resultant product characteristics of the tag. For example, the outer layers may be made from PLA, PBAT, or a combination of both PLA and PBAT.

In certain configurations, the outer layers may be made from PLA, PBAT, PBS, or a combination thereof. The he plant-based plastic or bioplastic may be polybutylene succinate (PBS), poly(butylene succinate-co-butylene adipate) (BPSA), or both.

The intermediate layer and/or outer layers may also include one or more additives. However, it is envisioned that any additives within the layers may also be environmentally friendly (e.g., recyclable). Such additives may be incorporated into the layers to further tune or modify material properties of the tag to meet industry demands. For example, the layers may include one or more impact modifiers (e.g., core/shell material), one or more colorants, one or more flame retardants, one or more fillers, one or more adhesives, other modifiers, or a combination thereof. The modifiers may modify one or more layers to ensure that the layers are UV-resistant, anti-fungal, anti-microbial, water resistant and/or repellant, or a combination thereof.

It should also be noted that the tag may vary in color. While white tags may be conventional or often required in the horticulture industry, any desired color may be possible by incorporating one or more color additives into the material. These colors may include, but are not limited to, black, blue, yellow, green, purple, orange, red, pink, or a combination thereof. As such, the tag may be even further personalized for a specific application.

As mentioned above, the tag may convey information regarding a particular horticultural item, such as a plant, produce item (e.g., fruit, vegetable, etc.), or both. To convey such information, one or more surfaces of the tag may advantageously be printed directly onto without the need of secondary coatings or layers. For example, one or more outer layers, the intermediate layer, or a combination thereof may be printed on to convey information. Similarly, the tags may also be free of surface treatments that may be found conventionally in other industries.

To even further provide tunability of the tag, one or more layers of the tag may have a specified surface finish. For example, it is envisioned that the outer layers may have a desired surface finish. The surface finish of the outer layers may differ or may be uniform. As such, different sides of the tag may provide a different visual look.

The specified surface finish may be free of a secondary coating yet still provide tunability of surfaces of the tag. One or more surfaces of the tag may have a matte finish, a semi-gloss finish, a shiny finish, or a combination thereof. It should be noted that within the aforementioned finish categories there may be even further modification to change the degree of a finish (e.g., one or more levels of semi-gloss finish). Beneficially, the one or more surfaces of the tag may be modified for a specific surface finish yet still maintain printability. For example, a first outer layer may have a matte surface finish while a second outer layer may have a gloss surface finish. Both the matte surface finish and the gloss surface finish may facilitate printing.

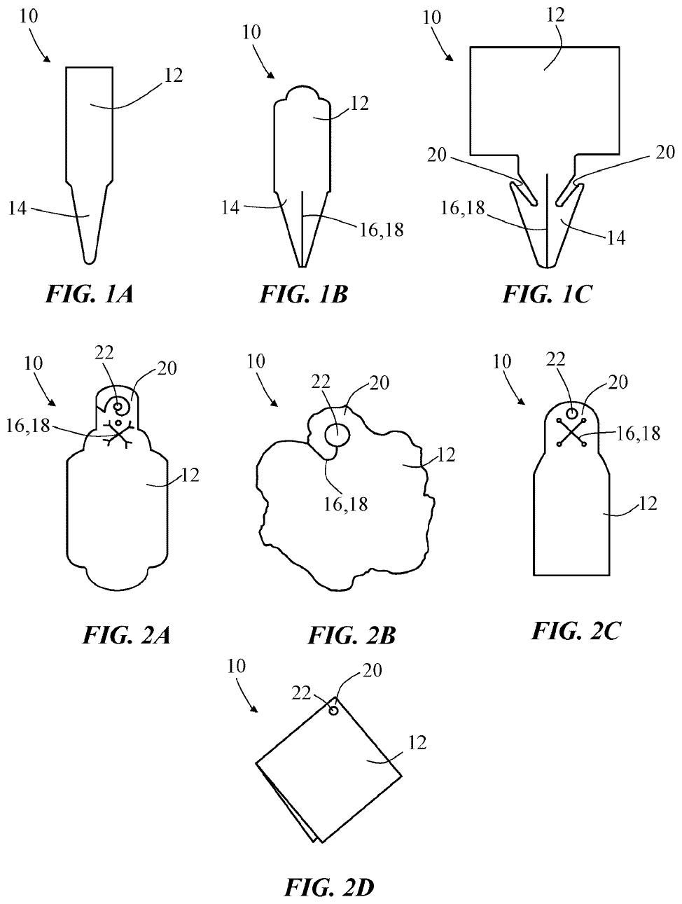

Turning now to the figures, FIG. 1A-1C illustrate various exemplary horticultural tags 10. The tags 10 may include a body 12. The body 12 may be a region of the tag 10 in which printing is completed. The printing may be text, images (e.g., pictures, QR codes, etc.), or both to convey the desired information about an associated plant. Furthermore, as discussed above, the printing may be completed in any color based upon a selected color of the tag 10. The body 12 may also be intended as a visual portion of the tag 10 that remains unobstructed when secured to or near the associated plant.

As shown in FIGS. 1A-1C, the tag 10 also includes an insertion portion 14. The insertion portion 14 may be configured for insertion into soil or other substrates in which the plant is inserted (e.g., packaging materials) to be positioned substantially near the associated plant. The insertion portion 14 may vary in size and/or shape to facilitate case of insertion into the soil or other substrates. It should be noted that printing may also be completed on the insertion portion 14. However, it is envisioned that the printing on the body 12 remains unobstructed while the printing on the insertion portion 14 may be unviewable after attachment or securing of the tag 10.

A transition region may be present between the body 12 and the insertion portion 14. For example, a step, notch, groove, cutout, contour, or a combination thereof may define a connecting region between the body 12 and the insertion portion 14. Thus, it may be gleaned from the present teachings that various shapes and features may be incorporated into the tag 10.

Similarly, as discussed above, one or more surfaces of the tag 10 formed from the body 12, the insertion portion 14, or both, may include a surface finish. For example, FIGS. 1A-1C may illustrate a first side of the tag 10 while a second opposing side is not shown. The first side of the tag 10 may have a matte finish while the opposing second side may have a semi-gloss or gloss finish. However, printing may still be completed on one or both sides of the tag 10 along the body 12, the insertion portion 14, or both regardless of the surface finish present.

The insertion portion 14 may also include one or more additional features that aid with insertion or attachment of the tag 10, help maintain structural integrity of the tag 10, help maintain positioning of the tag 10 once inserted or attached, or a combination thereof. The additional features may include one or more perforations 16, one or more score lines 18, or both. The perforations 16 and/or score lines 18 may extend anywhere along the tag 10 (i.e., the body 12 and/or the insertion portion 14) in any desired direction at a selected length. For example, as shown in FIG. 1B, the perforation 16 or score line 18 may extend to a distal tip of the insertion portion 14 up until a connecting region between the insertion portion 14 and the body 12.

The additional features located on the insertion portion 14 may also include one or more cutouts 22. The cutouts 22 may provide retention means for the insertion portion 14 after the insertion portion 14 is inserted into the soil or substrate retaining the plant. For example, the cutouts 22 may form one or more teeth, projections, fins, or a combination thereof that retain the insertion portion 14 in the ground or substrate. Additionally, an angle of the formed teeth, projections, fins, or a combination thereof may allow for easy insertion into the ground or substrate yet oppose a removal direction of the insertion portion 14.

FIGS. 2A-2D illustrate various exemplary horticultural tags 10. The tags 10 may include a body 12. The body 12 may be a region of the tag 10 in which printing is completed. The printing may be text, images (e.g., pictures, QR codes, etc.), or both to convey the desired information about an associated plant. Furthermore, as discussed above, the printing may be completed in any color based upon a selected color of the tag 10. The body 12 may also be intended as a visual portion of the tag 10 that remains unobstructed when secured to or near the associated plant.

As shown in FIGS. 2A-2D, the tag 10 may also include a hanging portion 20. The hanging portion 20 may be configured to hang the 10 directly or indirectly onto an associated plant. For example, the hanging portion 20 may include perforations 16, score lines 18, cutouts 22, or a combination adapted to secure the tag 10 to the associated plant. The perforations 16, score lines 18, cutouts 22, or a combination thereof may form a hanger to hang the tag 10 directly to the associated plant. Similarly, the perforations 16, score lines 18, cutouts 22, or a combination thereof may also receive a string or other connection means to indirectly attach the tag 10 to the associate plant.

As shown, the hanging portion 20 may vary in size and/or shape to meet industry requirements or requests. In certain configurations, such as the tag 10 illustrated in FIG. 2D, the hanging portion 20 may be free of any perforation 16 or score lines 18. Additionally, the cutout 22 may only extend through a single layer of a folded tag 10, thereby creating an inner portion in which additional information (e.g., text, images, etc.) may be displayed. It should be noted that printing may also be completed on the hanging portion 20. However, it is envisioned that the printing on the body 12 remains unobstructed while the printing on the hanging portion 20 may be unviewable after attachment or securing of the tag 10 to the associated plant.

A transition region may be present between the body 12 and the hanging portion 20. For example, a step, notch, groove, cutout, contour, or a combination thereof may define a connecting region between the body 12 and the hanging portion 20. Thus, it may be gleaned from the present teachings that various shapes and features may be incorporated into the tag 10.

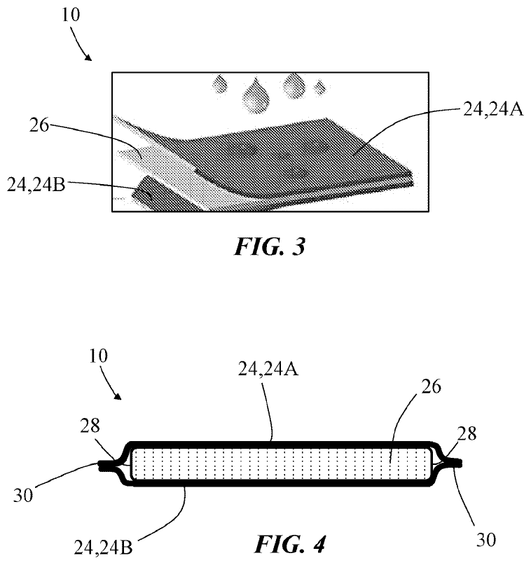

FIG. 3 illustrates a cross-sectional view of a horticultural tag 10 in accordance with the present teachings. As discussed above, the tag 10 may include a plurality of interconnected layers. For example, the tag 10 may include an intermediate 26 sandwiched between opposing outer layers 24. However, any number of layers may be utilized in accordance with the present teachings based on a given application. As shown, the intermediate layer may have a differing material (e.g., paperboard infused with wax) sandwiched between a first outer layer 24A and an opposing second outer layer 24B. The outer layers 24 may be extruded onto the intermediate layer 26, or vice versa, prior to die cutting a shape of the tag 10 (or any score lines, perforations, cut outs, etc. thereof) to create a substantially planar composite tag 10 configuration. Thus, the outer layers 24 may provide outer surfaces of the tag 10 that may be printed directly onto for any information being conveyed about an associate product (e.g., a plant). Similarly, the present configuration may advantageously provide a water resistant or waterproof composite material.

FIG. 4 illustrates a cross-sectional view of a horticultural tag 10 in accordance with the present teachings. Similar to FIG. 3, the tag 10 may include an intermediate layer 26 sandwiched between opposing outer layers 24. While in some cases it may not be needed, it is envisioned that a first outer layer 24A and a second outer layer 24B may be heat sealed at least partially or even fully around the intermediate layer 26 to seal the intermediate layer 26 therein.

For example, as shown in FIG. 4, the first outer layer 24A and the second outer layer 24B may be disposed on opposing surfaces of the intermediate layer 26. The outer layers 24 may then be heat sealed, skived, hemmed, or otherwise processed to form a seal along and around the intermediate layer 26. That is, the first outer layer 24A and the second outer layer 24B may bond to the intermediate layer 26, each other, or a combination thereof to form a seal and cover peripheral edges 28 of the intermediate layer 26. For example, the first outer layer 24A and the second outer layer 24B may at least partially adhere or otherwise bond to one another to form a seam 30 along or near the peripheral edges 28 of the intermediate layer 26. The seam 30 may be visible after forming of the tag 10. However, it is envisioned that the seam 30 may also be invisible to the naked eye upon forming the tag 10.

### ELEMENT LIST

10 Tag
12 Body
14 Insertion Portion
16 Perforation
18 Score Line
20 Hanging Portion
22 Cutout
24 Outer Layer
24A First Outer Layer
24B Second Outer Layer
26 Intermediate Layer
28 Peripheral Edge
30 Seam

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference herein in their entirety for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100 +/−15.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference herein in their entirety for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A horticultural tag comprising:
(a) a first outer layer made from a polymer;
(b) a second outer layer made from a polymer; and
(c) an intermediate layer made from a paperboard, wherein the paperboard is infused with wax prior to joining the first outer layer, the second outer layer, or both to the intermediate layer.

2. The horticultural tag of claim 1, where the first outer layer, the second outer layer, or both are made from a thermoplastic material.

3. The horticultural tag of claim 1, wherein the first outer layer is made from polyethylene.

4. The horticultural tag of claim 1, wherein the second outer layer is made from polyethylene.

5. The horticultural tag of claim 1, wherein the first outer layer, the second outer layer or both are made from low density polyethylene (LDPE).

6. The horticultural tag of claim 1, wherein the first outer layer and the second outer layer are made from the same material.

7. The horticultural tag of claim 1, wherein the first outer layer and the second outer layer are made from different materials.

8. The horticultural tag of any of claim 1, wherein the first outer layer and the second outer layer include a surface finish comprising one of a matte surface finish or a gloss surface finish.

9. The horticultural tag of claim 1, wherein the first outer layer, the second outer layer, or both include printing.

10. The horticultural tag of claim 1, wherein the first outer layer, the second outer layer, or both are made from a bio-based plastic and the horticultural tag is compostable.

11. A horticultural tag comprising:
(a) a first outer layer made from a thermoplastic;
(b) a second outer layer made from a thermoplastic; and
(c) an intermediate layer made from a paperboard, wherein the first outer layer, the second outer layer, or both are heat sealed to the intermediate layer to seal the intermediate layer therein.

12. The horticultural tag of claim 11, where the first outer layer, the second outer layer, or both are made from a plant-based plastic or bioplastic.

13. The horticultural tag of claim 11, wherein the first outer layer, the second outer layer, or both are made from polybutylene succinate (PBS).

14. The horticultural tag of claim 11, wherein the first outer layer, the second outer layer or both are biodegradable.

15. The horticultural tag of claim 11, wherein the first outer layer, the second outer layer, or both are heat sealed around peripheral edges of the intermediate layer such that the intermediate layer is fully covered by the first outer layer, the second outer layer, or both.

16. The horticultural tag of claim 11, wherein the horticultural tag is moisture wicking, moisture resistant, or both.

17. The horticultural tag of claim 11, wherein the intermediate layer is uncoated.

18. The horticultural tag of claim 11, wherein the first outer layer, the second outer layer, or both are extruded over the intermediate layer, and the resultant multi-layer material is die cut to form the horticultural tag.

19. The horticultural tag of claim 11, wherein the horticultural tag is corona treated to ensure adhesion during printing on the first outer layer, the second outer layer, or both.

20. The horticultural tag of claim 11, wherein the horticultural tag is heat-sealed after die cutting.
